(19) United States
(12) Patent Application Publication
(10) Pub. No.: US 2020/0110561 A1
(43) Pub. Date: Apr. 9, 2020

(54) IMAGE PROCESSING APPARATUS, METHOD OF CHANGING IMAGE COLOR, AND RECORDING MEDIUM STORING IMAGE COLOR CHANGE PROGRAM

(71) Applicant: Sharp Kabushiki Kaisha, Sakai City (JP)

(72) Inventor: SHOTA KANEKO, Sakai City (JP)

(21) Appl. No.: 16/591,266

(22) Filed: Oct. 2, 2019

(30) Foreign Application Priority Data
Oct. 5, 2018 (JP) 2018-190151

(51) Int. Cl. G06F 3/12

(52) U.S. Cl. CPC G06F 3/1208; G06F 3/1256

(57) ABSTRACT

An image forming apparatus to display an image, includes a controller, a touch panel display, a color change location specification part, and an approximate color image generator. The controller allows the touch panel display to display a preview image based on image data, selects a specific location of the preview image displayed by the color change location specification part, generates an approximate color image including an approximate color of the specific location selected by the approximate color image generator, and changes a color of an area including the specific location to a color selected from the approximate color image.

### BACKGROUND OF THE INVENTION

### Field of the Invention

The present invention relates to an image processing apparatus or the like.

### Description of the Background Art

An image forming apparatus including a display capable of previewing an image before printing has been recently known.

When an image to be output is adjusted or when the output setting is changed, the image previewed on a display screen is visually confirmed, and thus the finish of the image can be recognized before printing.

A known technique to change a color of an image before printing has been provided (see Japanese Unexamined Patent Application Publication No. 8-9179). In the technique, for example, an image, the color of which is conversed based on the original data and by a printer is previewed on a monitor screen of a computer, and a user selects a color conversion algorithm while looking at the previewed image and thereby the image is printed in a color desired by the user.

However, even within the printing color range of an image forming apparatus, the color is likely to greatly change depending on a monitor used by the user; therefore, it may be difficult to desirably print the image only by changing the color conversion algorithm.

Accordingly, a color printing apparatus disclosed as a prior art (see Japanese Unexamined Patent Application Publication No. 9-198217) includes, for example, a previewer, a specification part that specifies a color correction target on a preview screen of the previewer, a color correction part that performs color correction on print data of the color correction target, and a color printer that prints a print image, the color of which is corrected by the color correction part. When the print data is transmitted from a DTP editing device to the color printing apparatus, the print image is color-displayed in the preview screen of the previewer.

Thus, before actually printing the image, a user looks at the preview screen and thereby can check whether the image can be printed in a color desired by the user.

However, in the technique described in Japanese Unexamined Patent Application Publication No. 9-198217, when a color of the color correction target for color change is specified, the color correction part needs to select the color by “character color”, “color palette”, “color control panel”, or the like and the operation may be complicated. In particular, at the time of selecting an approximate color, it may be difficult to specify the color.

The present invention is thus made in view of a problem of the prior art, and an object of the present invention is to provide an image forming apparatus or the like that can easily specify a color desired by a use at the time of changing a color of an image.

### SUMMARY OF THE INVENTION

An image processing apparatus according to the present invention includes a controller and a display. The controller allows the display to display an image based on image data, selects a specific location of the displayed image, allows the display to display an image indicating an approximate color to a color of the selected specific location, and changes a color of an area including the selected specific location to a color selected from the image indicating the approximate color.

Further, a method of changing a color of an image in an image processing apparatus including a controller and a display, includes: displaying on the display an image based on image data; selecting a specific location of the displayed image; displaying on the display an image indicating an approximate color to a color of the selected specific location; and changing a color of an image including the specific location to a color selected from the image indicating the approximate color.

Furthermore, a recording medium storing an image color change program according to the present invention is applied in an image processing apparatus including a controller and a display. The image color change program allows a computer to implement: an image display function to display on the display an image based on image data; a specific location selection function to select a specific location of the displayed image; an approximate color display function to display on the display an image indicating an approximate color to a color of the selected specific location; and a color change function to change a color of an area including the specific location to a color selected from the image indicating the approximate color.

According to the image processing apparatus of the present invention, the image processing apparatus including the controller and the display is designed such that the controller allows the display to display an image based on image data, selects a specific location of the displayed image, allows the display to display an image indicating an approximate color to a color of the selected specific location, and changes a color of an area including the specific location to a color selected from the image indicating the approximate color. Thus, the image processing apparatus superior in user interface can be provided. In the case of changing the color of the specific location of the image, the image processing apparatus can easily specify a color desired by a user from the image indicating the approximate color.

According to the image processing apparatus of the present invention, the image processing apparatus including the controller and the display is configured such that the controller allows the display to display an image based on image data, selects a specific location of the displayed image, allows the display to display an image indicating an approximate color to the color of the selected specific location, and changes the color of the area including the specific location to the color selected from the image indicating the approximate color. Thus, the image processing apparatus superior in user interface can be provided. In the case of changing the color of the image, the image processing apparatus can easily specify a color desired by a user from the image indicating the approximate color.

Further according to the recording medium storing the image color change program of the present invention is applied in the image processing apparatus including the controller and the display. The image color change program allows a computer to implement: an image display function to display on the display an image based on image data; a specific location selection function to select a specific location of the displayed image; an approximate color display function to display on the display an image indicating an approximate color to a color of the selected specific location; and a color change function to change a color of an area including the specific location to a color selected from the image indicating the approximate color. The recording medium storing the image color change program that can realize the image processing apparatus superior in user interface can be provided. In the case of changing the color of the image, the image processing apparatus can easily specify a color desired by a user from the image indicating the approximate color.

### BRIEF DESCRIPTION OF THE DRAWINGS

FIG. 1 is a block diagram illustrating a configuration of main parts of an image forming apparatus according to a first embodiment.

FIG. 2 is an explanatory diagram illustrating the entire configuration of the image forming apparatus.

FIG. 3A is an explanatory diagram illustrating an example of displaying a preview image on a touch panel display of the image forming apparatus.

FIG. 3B is an explanatory diagram illustrating an example of displaying the preview image and an approximate color image on the touch panel display.

FIG. 3C is an explanatory diagram illustrating an example of displaying on the touch panel display a preview image after color change.

FIG. 4 is a flowchart illustrating steps of color change processing of changing a color of a specific location of a preview image displayed on the touch panel display of the image forming apparatus.

FIG. 5 is a block diagram illustrating a configuration of main parts of an image forming apparatus according to a second embodiment.

FIG. 6 is an explanatory diagram illustrating, in a two-dimensional plane, a Lab color space of an image in the image forming apparatus.

FIG. 7 is a block diagram illustrating a configuration of main parts of an image forming apparatus according to a third embodiment.

FIG. 8A is an explanatory diagram illustrating an example of displaying a preview image on the touch panel display of the image forming apparatus.

FIG. 8B is an explanatory diagram illustrating an example of displaying the preview image and an approximate color image on the touch panel display.

FIG. 8C is an explanatory diagram illustrating an example of a mask image indicating a range of an area including a specific location of the preview image, which is subjected to color change.

FIG. 8D is an explanatory diagram illustrating an example of displaying on the touch panel display a preview image after color change.

FIG. 9 is a block diagram illustrating a configuration of main parts of an image forming apparatus according to a fourth embodiment.

FIG. 10A is an explanatory diagram illustrating an example of displaying a preview image on the touch panel display of the image forming apparatus.

FIG. 10B is an explanatory diagram illustrating an example of displaying the preview image and an approximate color image on the touch panel display.

FIG. 10C is an explanatory diagram illustrating an example of displaying an image indicating a profile of a specific location of the preview image, which is subjected to color change.

FIG. 10D is an explanatory diagram illustrating an example of displaying on the touch panel a preview image after color change.

### DESCRIPTION OF THE PREFERRED EMBODIMENTS

### First Embodiment

Hereinafter, embodiments of the present invention will be described with reference to the drawings.

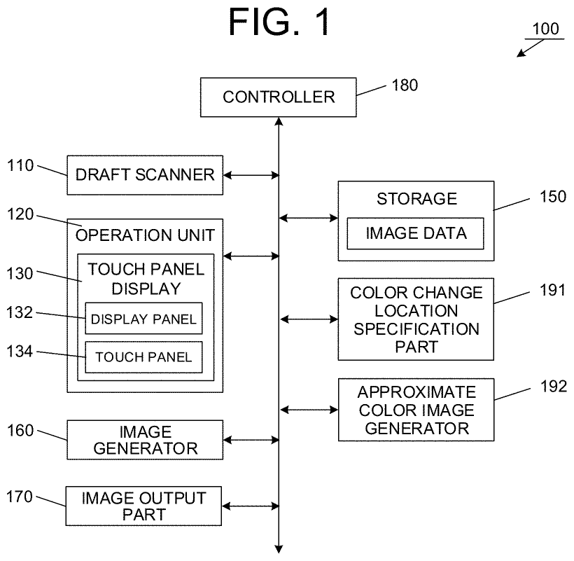

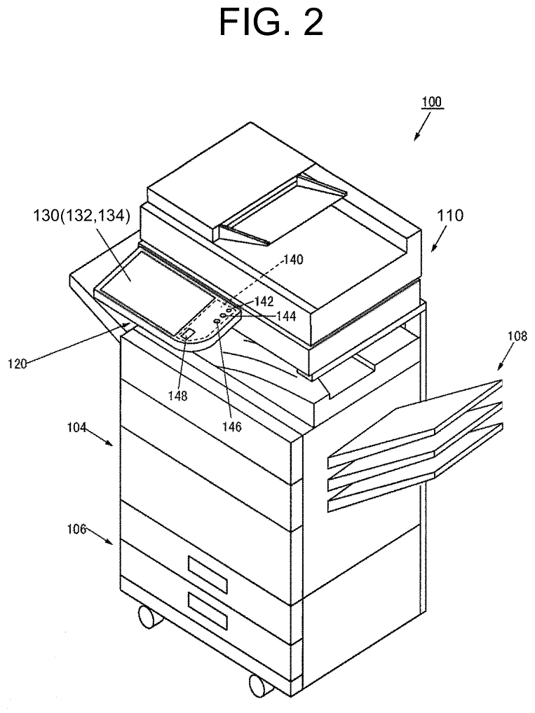

FIG. 1 is a block diagram illustrating a configuration of main parts of an image forming apparatus according to a first embodiment. FIG. 2 is an explanatory diagram illustrating the entire configuration of the image forming apparatus.

In the first embodiment, as illustrated in FIG. 1, an image forming apparatus 100 according to an aspect of an image processing apparatus includes: a draft scanner 110 to which image data is input; an operation unit 120 provided with a touch panel display (display) 130; a storage 150; an image generator 160 that generates an image based on the image data; an image output part 170 that outputs, as a preview image, the image generated based on the image data; and a controller 180 that controls processing operations of the parts of the image forming apparatus 100.

The controller 180 allows the touch panel display 130 to display the preview image based on the image data, selects a location (specific location) of the preview image, which is specified by a user, and allows the touch panel display 130 to display an approximate color image including an approximate color to a color of the selected specific location. In addition, the controller 180 changes a color of an area including the specific location to a color selected by the user from the approximate color image.

### Configuration of Image Forming Apparatus

Here, the basic configuration of the image forming apparatus 100 according to the first embodiment will be described.

The configuration according to the present invention may be applied to an image processing apparatus other than such an image forming apparatus or to an electrical device.

The image forming apparatus 100 generates an image on recording sheet by an electrographic method.

Further, the image forming apparatus 100 includes, as operation modes, a copy mode, a facsimile mode (FAX mode), a document filing mode (a mode in which a scanned image is stored in the storage inside the image forming apparatus), and a mail mode (a mode in which an e-mail is sent with a scanned image attached). Furthermore, the image forming apparatus 100 may further include a network printer mode.

As illustrated in FIG. 2, the image forming apparatus 100 mainly includes the draft scanner 110, an image forming part 104, a paper feeder 106, a paper processor 108, the operation unit 120, and the like.

The operation unit 120 includes the touch panel display 130 and a display operation part 140. The touch panel display 130 includes a display panel 132 constituted by a liquid crystal panel or the like, and a touch panel 134.

A home screen on which an operation mode of the image forming apparatus 100 is selected, a current state of the image forming apparatus 100, an address specified status, a job processing status, or the like is displayed on the display panel 132 in the touch panel display 130.

A selection button which is a software button is displayed on a preview display area of the display panel 132. When the area where the selection button is displayed is pressed with a finger, the touch panel 134 detects the pressed position. The display position of the selection button is compared on a program with the position where the touch panel 134 is pressed and thus selection of an operation mode of the image forming apparatus 100, function setting, or operation instruction is made or another operation is performed. In addition to such touch operations, the image forming apparatus 100 may support gesture operations.

The display operation part 140 includes a pilot lamp 142, a power key 144, an energy conservation key (hereinafter referred to as “energy saving key”) 146, and a home key with 148 which a display screen on the touch panel display 130 is returned to the home screen on which an operation mode can be selected.

As described above, the image forming apparatus 100 includes the touch panel display 130 as a main operation device, and includes the display operation part 140 constituted by a hardware key and the pilot lamp 142. The key of the display operation part 140 is configured as a hardware button compared with the software button constituted by the touch panel display 130.

In addition, the image forming apparatus 100 is not limited to an apparatus including the display operation part 140 configured as just described. Alternatively, the image forming apparatus 100 may include the touch panel display 130 only. The image forming apparatus 100 may be configured in any manner as long as the apparatus is configured such that when a user selects an operation mode on the home screen displayed on the touch panel display 130, the home screen shifts to an initial screen of the selected operation mode.

The storage 150 stores image data of a draft scanned by the image forming apparatus 100. In addition, programs, data, and the like required for controlling the operation of the image forming apparatus 100 are stored in the storage 150.

The controller 180 controls the image forming apparatus 100 in accordance with the programs and data stored in the storage 150 and executes control relating to each function of the image forming apparatus 100.

### Characteristic Configuration of Image Forming Apparatus

Next, the characteristic configuration of the image forming apparatus 100 according to the first embodiment will be described with reference to the drawings.

As illustrated in FIG. 1, the image forming apparatus 100 according to the first embodiment includes the draft scanner 110, the operation unit 120, the storage 150, the image generator 160, the image output part 170, and the controller 180 that are described above, and in addition to such components, the image forming apparatus 100 further includes a color change location specification part 191 and an approximate color image generator 192.

In addition to the control of each function of the image forming apparatus 100, the controller 180 executes control for changing a color of an image displayed on the touch panel display 130 of the operation unit 120.

The color change location specification part 191 selects a specific location in a preview image displayed on the touch panel display 130 of the operation unit 120.

The approximate color image generator 192 generates an approximate color image including an approximate color to a color of the selected specific location.

In the first embodiment, the controller 180 specifies the color of the location selected from the preview image by the user with the color change location specification part 191, as a color to be changed.

Further, the controller 180 allows the touch panel display 130 to display the approximate color image generated by the approximate color image generator 192.

Furthermore, the controller 180 changes a color of an area including the specific location specified by the user to a color selected from the approximate color image.

Moreover, the controller 180 allows the touch panel display 130 to display a preview image of a print image after color change.

### Operation to Change a Color of an Image

Next, a case where a color of a specific location of an image is changed in the image forming apparatus 100 according to the first embodiment will be described with reference to the drawings.

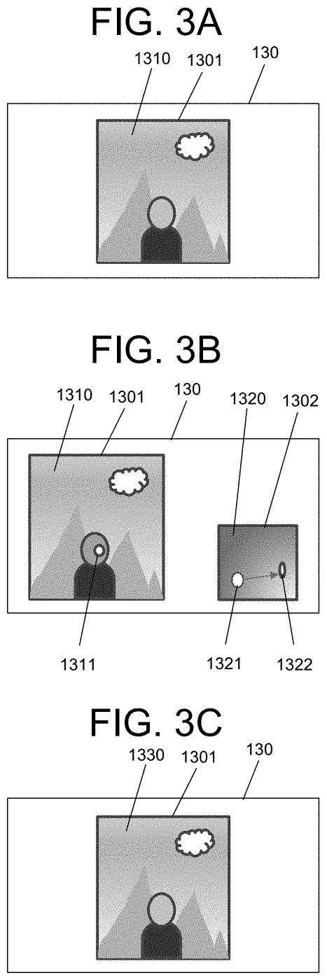

FIG. 3A is an explanatory diagram illustrating an example of displaying a preview image on the touch panel display of the image forming apparatus according to the first embodiment. FIG. 3B is an explanatory diagram illustrating an example of displaying the preview image and an approximate color image on the touch panel display. FIG. 3C is an explanatory diagram illustrating an example of displaying on the touch panel display a preview image after color change.

In the case of changing a color of a specific location of an output image (a print image), as illustrated in FIG. 3A, a preview image 1310 based on the image data is displayed on the touch panel display 130, and a location in the preview image 1310, which is subjected to color change is specified and thereby the color is changed.

In the first embodiment, in the case of displaying the preview image 1310 on the touch panel display 130, a first display area 1301 for displaying a preview image is provided; therefore, the preview image 1310 is displayed in the first display area 1301.

The preview image 1310 is a preview image generated based on the image data by the image generator 160. In addition, the preview image displayed on the touch panel display 130 may be a preview image of a print image predicted based on the image data.

When a location in the preview image 1310, which is subjected to color change by the user is specified, as illustrated in FIG. 3B, an approximate color image 1320 including an approximate color to a color of a specific location 1311 specified by the user is displayed on the touch panel display 130. The approximate color in a preliminarily-set range is displayed in the approximate color image 1320.

In the first embodiment, in the case of displaying the approximate color image 1320 on the touch panel display 130, a second display area 1302 for displaying an approximate color image is provided; therefore, the approximate color image 1320 is displayed in the second display area 1302.

When a desired color (target color) 1322 desired by the user is selected in the approximate color image 1320 as illustrated in FIG. 3B, a p review image 1330 of an output image after color change is displayed on the touch panel display 130 as illustrated in FIG. 3C.

The color of the location specified by the user is indicated by reference numeral 1321 in FIG. 3B.

In the first embodiment, instead of the preview image 1310, the preview image 1330, the color of which is changed is displayed in the first display area 1301.

In addition, in the case of displaying the preview image 1330 of the output image, the color of which is changed, a third display area is provided on the touch panel display 130, and thus the preview image 1330 of the output image, the color of which is changed may be displayed in the third display area.

### Color Change Operation Processing

Next, the processing of changing a color of a specific location of a preview image displayed on the touch panel display 130 in the image forming apparatus 100 according to the first embodiment will be described with a flowchart.

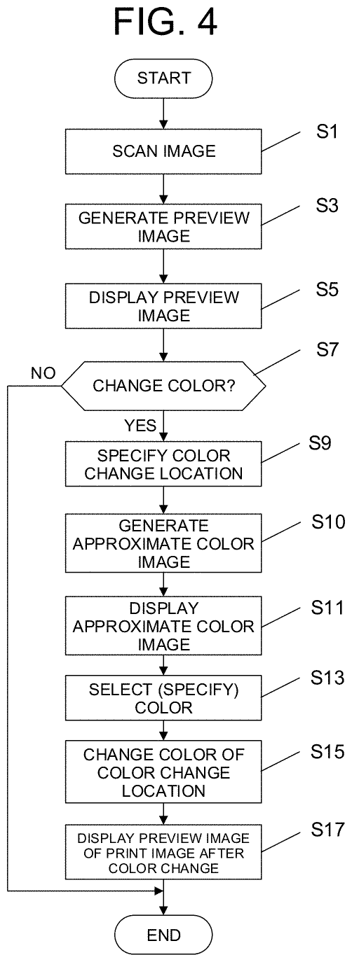

FIG. 4 is a flowchart illustrating steps of color change processing of changing a color of a specific location of a preview image displayed on the touch panel display of the image forming apparatus according to the first embodiment.

In the case of changing a color of a specific location of a preview image displayed on the touch panel display 130 in the image forming apparatus 100 according to the first embodiment, an image is firstly scanned from a draft as illustrated in FIG. 4 (step S1). The scanned image data is stored in the storage 150.

Then, the preview image 1310 is generated based on the image data (step S3), and the generated preview image 1310 is displayed in the first display area 1301 on the touch panel display 130 (step S5).

Then, whether the color of the image is changed is determined (selected) (step S7). When it is determined in step S7 that the color of the image is not to be changed, the color change processing ends. In contrast, when it is determined in step S7 that the color of the image is to be changed, a location in the preview image 1310, which is subjected to color change is specified (step S9).

In step S9, the location in the preview image 1310, which is subjected to color change is specified by the color change location specification part 191.

Then, the approximate color image 1320 including an approximate color to a color of the specified location is generated by the approximate color image generator 192 (step S10). Subsequently, the approximate color image 1320 is displayed in the second display area 1302 (step S11).

Then, when the color to be changed in the approximate color image 1320 is specified by the user (step S13), the area subjected to color change is changed to the specified color (step S15). Afterward, the preview image 1330 after color change is displayed on the touch panel display 130 (step S17). As described above, the image color change processing is executed.

The configuration described above is provided; therefore, the image forming apparatus 100 according to the first embodiment includes the draft scanner 110, the touch panel display 130, the storage 150, the image generator 160, the image output part 170, and the controller 180. The image forming apparatus 100 further includes the color change location specification part 191 and the approximate color image generator 192. The controller 180 allows the touch panel display 130 to display the preview image 1310. A specific location in the preview image 1310, which is subjected to color change is selected by the color change location specification part 191. The approximate color image 1320 generated by the approximate color image generator 192 is displayed on the touch panel display 130. Thus, the color of the area including the specific location can be changed to the color selected from the approximate color image 1320. Consequently, in the case of changing the color of the specific location of the image, the color desired by the user can be easily specified from the approximate color image 1320.

Additionally, in the first embodiment, the preview image 1330 of the print image after color change is displayed on the touch panel display 130; therefore, prior to printing, the user can check the print image after color change. Consequently, color change can be performed as desired by the user while printing is not performed uselessly.

### Second Embodiment

Next, a second embodiment of the present invention will be described. In the case of changing a color of an image in an image forming apparatus according to the second embodiment, a color of a specific location subjected to color change is changed to a selected color. At this time, the approximate color of an area located adjacent to the specific location subjected to color change is corrected.

Further, in the second embodiment, the range of correction of the approximate color of the area located adjacent to the specific location subjected to color change can be set.

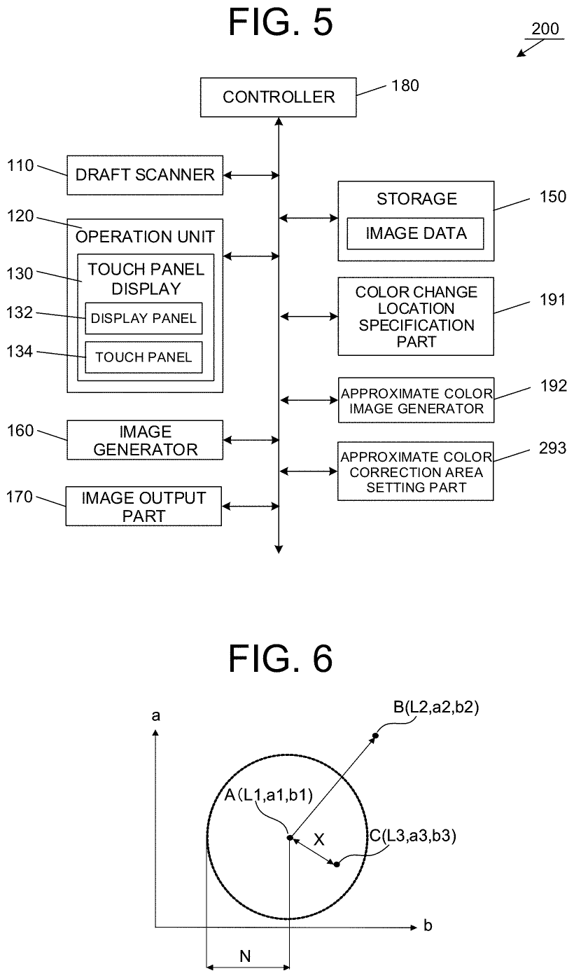

FIG. 5 is a block diagram illustrating a configuration of main parts of the image forming apparatus according to the second embodiment. FIG. 6 is an explanatory diagram illustrating, in a two-dimensional plane, a Lab color space of an image in the image forming apparatus. In addition, if the configuration of the image forming apparatus according to the second embodiment is the same as that of the image forming apparatus according to the first embodiment, the description thereof will be omitted and the configuration of the image forming apparatus according to the second embodiment is assigned the same reference numerals as those of the first embodiment.

As illustrated in FIG. 5, in addition to the configuration of the image forming apparatus 100 according to the first embodiment, an image forming apparatus 200 according to the second embodiment further includes an approximate color correction area setting part 293.

The approximate color correction area setting part 293 corrects an approximate color of an area located adjacent to a specific location subjected to color change. In addition, the range of correction of the approximate color of the area located adjacent to the specific location subjected to color change (the range will be hereinafter referred to as “approximate color correction area”) can be set by the approximate color correction area setting part 293. An example of color correction of the approximate color correction area will be illustrated below.

As illustrated in FIG. 6, point A, the color of which is desired to be changed, point B after color change, and point C of an approximate color will be as follows when being indicated in a color space of a Lab color specification system (L, a, b).

Point, the color of which is desired to be changed: A (L1, a1, b1)

Point after color change: B (L2, a2, b2)

Point of approximate color: C (L3, a3, b3)

In a condition where “N” represents a correction width indicating to what extent the color is to be corrected,

a distance X between point A and point C on a color space is obtained from formula 1

X=\sqrt{(L1−L3)²+(a1−a3)²+(b1−b3)²} [Formula 1]

and the amount of change ΔC (ΔL, Δa, Δb) due to the correction of point C is obtained from formulas 2 to 5.

$$\begin{matrix}Δ L = - \frac{L 2 - L 1}{N} ( X - N ) , \\ wherein \text{:} X \leq N & [ Formula 2 ] \\ Δ α = - \frac{α 2 - α 1}{N} ( X - N ) , \\ wherein \text{:} X \leq N & [ Formula 3 ] \\ Δ b = - \frac{b 2 - b 1}{N} ( X - N ) , & [ Formula 4 ] ] \\ wherein \text{:} X \leq N & \\ When X > N , Δ L = Δ α = Δ b = 0 & [ Formula 5 ]\end{matrix}$$

Further, correction is made as follows when the colors of plural points are changed. In a condition where points, the colors of which are desired to be changed are A1(LA1, aA1, bA1), A2(LA2, aA2, bA2) . . . ; points after color change are B1(LB1, aB1, bB1), B2(LB2, aB2, bB2) . . . ; and distances X1, X2 . . . between A1, A2, . . . and approximate color C, S is calculated from formula 6 as below (excluding a distance Xi between point Ai and approximate color C where Xi>N).

$$S = \frac{1}{X 1} + \frac{1}{X 2} \qquad [ Formula 6 ]$$

The amount of change ΔC (ΔL, Δa, Δb) due to the correction of point C is obtained from formulas 7 to 9.

$$\begin{matrix}Δ L = {\sum }_{{i = 1}_{{X}_{i} \leq N}} - \frac{{LB}_{i} - {LA}_{i}}{N} \frac{1}{{SX}_{i}} ( {X}_{i} - N ) & [ Formula 7 ] \\ Δ a = {\sum }_{{i = 1}_{{X}_{i} \leq N}} - \frac{{aB}_{i} - {aA}_{i}}{N} \frac{1}{{SX}_{i}} ( {X}_{i} - N ) & [ Formula 8 ] \\ Δ b = {\sum }_{{i = 1}_{{X}_{i} \leq N}} - \frac{{bB}_{i} - {bA}_{i}}{N} \frac{1}{{SX}_{i}} ( {X}_{i} - N ) & [ Formula 9 ]\end{matrix}$$

With the configuration as described above, in addition to the configuration of the image forming apparatus 100, the image forming apparatus 200 according to the second embodiment further includes the approximate color correction area setting part 293. Thus, in the case of changing a color of an image, an approximate color of an area located adjacent to a specific location subjected to color change can be changed.

Moreover, according to the second embodiment, a range of an approximate color correction area is set by the approximate color correction area setting part 293. Therefore, the range of the approximate color correction area can be easily set depending on the size of the area of the approximate color subjected to color change.

### Third Embodiment

Next, a third embodiment of the present invention will be described. In the case of changing a color of an image in an image forming apparatus according to the third embodiment, an image indicating a range of an area including a specific location subjected to color change, a so-called “mask image” is displayed.

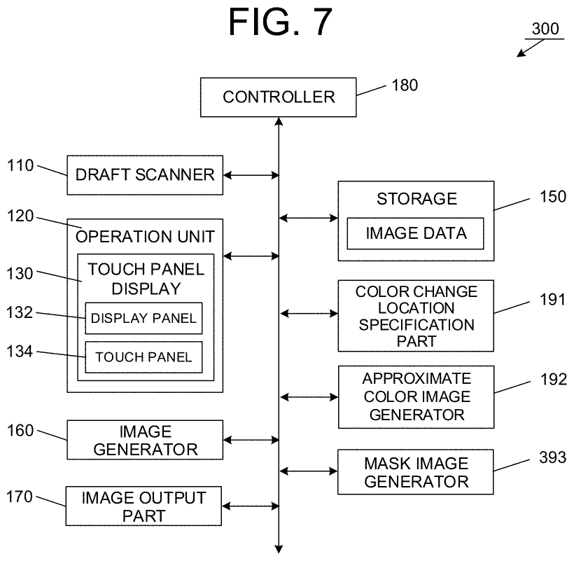

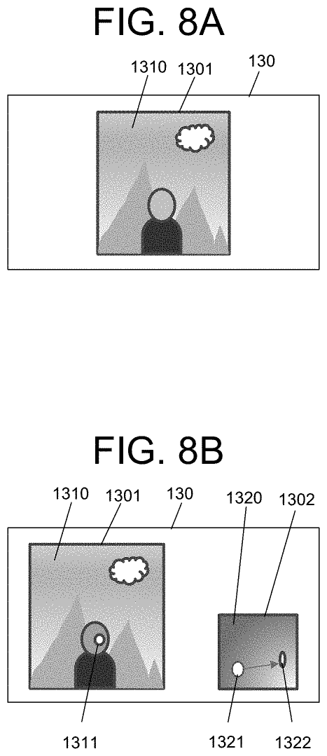

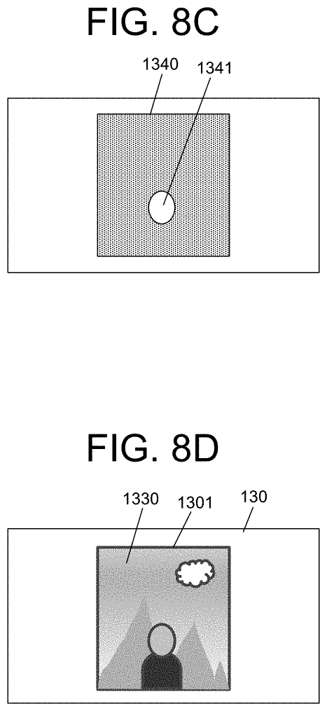

FIG. 7 is a block diagram illustrating a configuration of main parts of the image forming apparatus according to the third embodiment. FIG. 8A is an explanatory diagram illustrating an example of displaying a preview image on the touch panel display of the image forming apparatus. FIG. 8B is an explanatory diagram illustrating an example of displaying the preview image and an approximate color image on the touch panel display. FIG. 8C is an explanatory diagram illustrating an example of a mask image indicating a range of an area including a specific location of the preview image, which is subjected to color change. FIG. 8D is an explanatory diagram illustrating an example of displaying on the touch panel display a preview image after color change. In addition, if the configuration of the image forming apparatus according to the third embodiment is the same as that of the image forming apparatus according to the first embodiment, the description thereof will be omitted and the configuration of the image forming apparatus according to the third embodiment is assigned the same reference numerals as those of the first embodiment.

### Characteristic Configuration of Image Forming Apparatus

As illustrated in FIG. 7, in addition to the configuration of the image forming apparatus 100 according to the first embodiment, an image forming apparatus 300 according to the third embodiment further includes a mask image generator 393.

The mask image generator 393 generates an image indicating a range of an area of a specific location subjected to color change, a so-called “mask image”.

In the case of changing a color of a specific location of an output image (a print image) in the third embodiment, in the same way as in the first embodiment, as illustrated in FIG. 8A, a preview image 1310 based on the image data is displayed on the touch panel display 130, and a location in the preview image 1310, which is subjected to color change is specified and thereby the color is changed.

In the case of displaying the preview image 1310 on the touch panel display 130, a first display area 1301 for displaying a preview image is provided; therefore, the preview image 1310 is displayed in the first display area 1301.

The preview image 1310 is a preview image generated based on the image data by the image generator 160. In addition, the preview image displayed on the touch panel display 130 may be a preview image of a print image predicted based on the image data.

When the location in the preview image 1310, which is subjected to color change by a user is specified, as illustrated in FIG. 8B, an approximate color image 1320 including an approximate color to a color of a specific location 1311 specified by the user is displayed on the touch panel display 130. The approximate color in a preliminarily-set range is displayed in the approximate color image 1320.

In addition, a mask image 1340 indicating a range of a color change area 1341 including the specific location 1311 in the preview image 1310, which is subjected to color change is displayed in the third embodiment as illustrated in FIG. 8C.

The mask image 1340 may be displayed at the same time as the preview image 1310 illustrated in FIG. 8A is displayed. Alternatively, the mask image 1340 may be displayed at the same time as the preview image 1310 and the approximate color image 1320 that are illustrated in FIG. 8B are displayed.

Further, the mask image 1340 is be transmissively displayed (for example, semi-transparently displayed) and thus is superimposed on the original preview image 1310. Therefore, the original preview image 1310 may be transmissively displayed.

Furthermore, in the same way as in the first embodiment, instead of the preview image 1310, a preview image 1330 of an output image, the color of which is changed may be displayed in the first display area 1301 in the third embodiment.

With the configuration described above, the image forming apparatus 300 according to the third embodiment includes the mask image generator 393. Thus, on the touch panel display 130, the specific location in the preview image 1310, which is subjected to color change can be clarified by the mask image 1340. Consequently, the specific location, the color of which is to be changed can be easily checked.

### Fourth Embodiment

Next, a fourth embodiment according to the present invention will be described. The fourth embodiment is characterized in that, in the image forming apparatus 100, an output image is provided with plural profiles, and thus the profile is changed for each area, the color of which is to be changed.

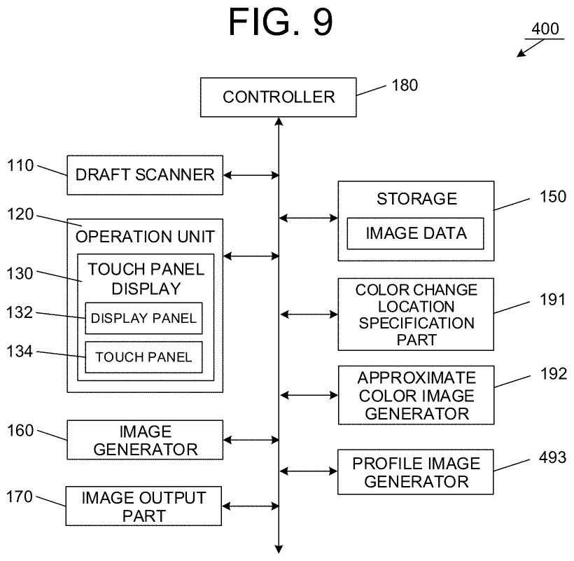

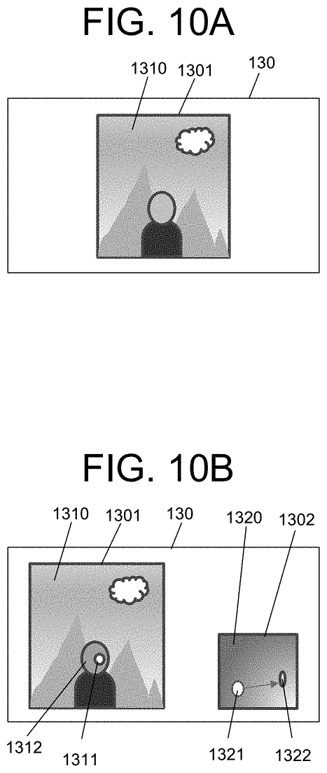

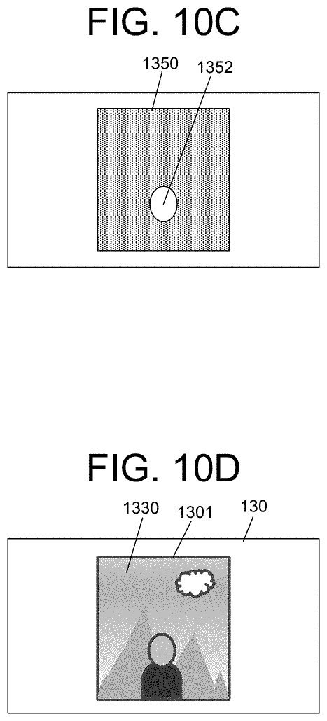

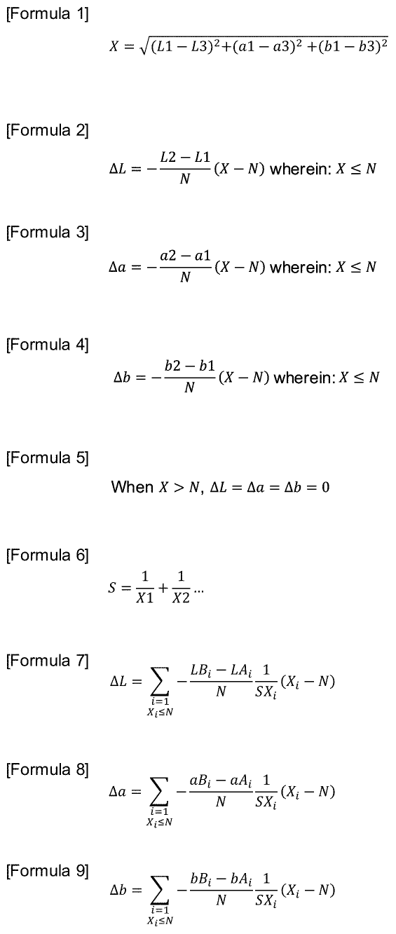

FIG. 9 is a block diagram illustrating a configuration of main parts of an image forming apparatus according to the fourth embodiment. FIG. 10A is an explanatory diagram illustrating an example of displaying a preview image on the touch panel display of the image forming apparatus. FIG. 10B is an explanatory diagram illustrating an example of displaying the preview image and an approximate color image on the touch panel display. FIG. 10C is an explanatory diagram illustrating an example of displaying an image indicating a profile of a specific location of the preview image, which is subjected to color change. FIG. 10D is an explanatory diagram illustrating an example of displaying on the touch panel a preview image after color change. In addition, if the configuration of the image forming apparatus according to the fourth embodiment is the same as that of the image forming apparatus according to the first embodiment, the description thereof will be omitted and the configuration of the image forming apparatus according to the fourth embodiment is assigned the same reference numerals as those of the first embodiment.

### Characteristic Configuration of Image Forming Apparatus

As illustrated in FIG. 9, in addition to the image forming apparatus 100 according to the first embodiment, an image forming apparatus 400 according to the fourth embodiment further includes a profile image generator 493.

The profile image generator 493 generates a profile image for a specific location, the color of which is to be changed.

In the case of changing a color of a specific location of an output image (a print image) in the fourth embodiment, in the same way as in the first embodiment, as illustrated in FIG. 10A, a preview image 1310 based on the image data is displayed on the touch panel display 130, and a location in the preview image 1310, which is subjected to color change is specified and thereby the color is changed.

In the case of displaying the preview image 1310 on the touch panel display 130, a first display area 1301 for displaying a preview image is provided; therefore, the preview image 1310 is displayed in the first display area 1301.

The preview image 1310 is a preview image generated based on the image data by the image generator 160. In addition, the preview image displayed on the touch panel display 130 may be a preview image of a print image predicted based on the image data.

When the location in the preview image 1310, which is subjected to color change by a user is specified, as illustrated in FIG. 10B, an approximate color image 1320 including an approximate color to a color of a specific location 1311 specified by the user is displayed on the touch panel display 130. The approximate color in a preliminarily-set range is displayed in the approximate color image 1320.

In addition, in the fourth embodiment as illustrated in FIG. 10C, a profile image 1350 including an image area 1352 of the specific location 1311 is displayed to correspond to the specific location 1311 in the preview image 1310, which is subjected to color change.

The profile image 1350 is generated by the profile image generator 493 to correspond to a specified location, the color of which is to be changed. In FIG. 10C, the profile image 1350 including the image area 1352 corresponding to an area 1312 of the face of the preview image 1310 is generated.

For example, the profile may be divided at the boundary where the color changes greatly, for example, between the area 1312 of the face and the background in the preview image 1310. Alternatively, the distance on the image from a location, the color of which is changed, the degree of color similarity, or the like may determine a threshold.

Further, in the same way as in the first embodiment, instead of the preview image 1310, a preview image 1330 of an output image, the color of which is changed may be displayed in the first display area 1301 in the fourth embodiment.

With the configuration described above, the image forming apparatus 400 according to the fourth embodiment includes the profile image generator 493. Thus, when plural specific locations in the preview image 1310, which are subjected to color change are specified on the touch panel display 130, plural profile images can be generated respectively for the plural specific locations, the color of each of which is to be changed. Therefore, the specific locations, the color of each of which is to be changed can be respectively clarified. Consequently, the specific locations, the color of each of which is to be changed can be easily checked.

Additionally, in the foregoing embodiments, the image forming apparatus is described as an example of a mode of an image processing apparatus that changes a color of a displayed image. Alternatively, the techniques described above are adopted into a terminal such as a PC (personal computer) or the like including, for example, a monitor (display), and thus before printing from a printer (the image forming apparatus), the image data of a print image is displayed on a screen of the monitor and the color of the image data may be changed on the screen of the monitor.

As described above, the present invention is not limited to the foregoing embodiments, and various changes can be made within the scope of the claims. It will be understood by the skilled person that various changes or modifications can be made within the scope of the claims. In other words, embodiments obtained by combining technical means appropriately modified without departing from the scope of the present invention may also be included in the technical scope of the present invention.

### DESCRIPTION OF REFERENCE NUMERALS

100, 200, 300, 400 Image forming apparatus (image processing apparatus)
130 Touch Panel Display (display)
150 Storage
160 Image generator
170 Image output part
180 Controller
191 Color change location specification part
192 Approximate color image generator
293 Approximate color correction area setting part
393 Mask image generator
493 Profile image generator
1301 First display area
1302 Second display area 1310, 1330 Preview image
1311 Specific location
1312 Area
1320 Approximate color image
1340 Mask image
1341 Color change area
1350 Profile image
1352 Image area

What is claimed is:

1. An image processing apparatus comprising:
a controller and a display,
wherein the controller allows the display to display an image based on image data, selects a specific location of the displayed image, allows the display to display an image indicating an approximate color to a color of the selected specific location, and changes a color of an area including the selected specific location to a color selected from the image indicating the approximate color.

2. The image processing apparatus according to claim 1, wherein the display includes plural display areas, and
the controller allows the image based on the image data to be displayed in a first display area and allows the image indicating the approximate color to the color of the selected specific location to be displayed in a second display area.

3. The image processing apparatus according to claim 1, wherein the controller allows the display to display a preview image of a print image based on the image data.

4. The image processing apparatus according to claim 1, wherein when changing the color of the selected specific location subjected to color change to a selected color, the controller corrects an approximate color of an area located adjacent to the selected specific location subjected to color change.

5. The image processing apparatus according to claim 4, wherein the controller can set a range of correction of the approximate color of the area located adjacent to the selected specific location subjected to color change.

6. The image processing apparatus according to claim 1, wherein the controller allows the display to display an image indicating a range of an area including the selected specific location subjected to color change.

7. The image processing apparatus according to claim 1, wherein the controller allows the display to display a preview image of a print image after color change.

8. The image processing apparatus according to claim 1, comprising plural profiles, wherein the profiles are changed for each of areas subjected to color change.

9. A method of changing a color of an image in an image processing apparatus including a controller and a display, the method comprising:
displaying on the display an image based on image data;
selecting a specific location of the displayed image;
displaying on the display an image indicating an approximate color to a color of the selected specific location; and
changing a color of an area including the selected specific location to a color selected from the image indicating the approximate color.

10. A non-transitory recording medium computer-readably storing an image color change program applied in an image processing apparatus including a controller and a display, the image color change program causing a computer to implement:
an image display function to display on the display an image based on image data;
a specific location selection function to select a specific location of the displayed image;
an approximate color display function to display on the display an image indicating an approximate color to a color of the selected specific location; and
a color change function to change a color of an area including the selected specific location to a color selected from the image indicating the approximate color.
